(19) United States
(12) Patent Application Publication
(10) Pub. No.: US 2010/0005133 A1
(43) Pub. Date: Jan. 7, 2010

(54) APPARATUS AND METHOD FOR GENERATING PERMUTATION SEQUENCE IN A BROADBAND WIRELESS COMMUNICATION SYSTEM

(75) Inventors: Seung-Hoon CHOI, Suwon-si (KR); Sung-Eun PARK, Seoul (KR); Tae-Young KIM, Seongnam-si (KR); Chi-Woo LIM, Suwon-si (KR); Song-Nam HONG, Suwon-si (KR); Ho-Kyu CHOI, Seongnam-si (KR); Jae-Weon CHO, Gwacheon-si (KR)

Correspondence Address: Maeng-Ho Shin;Jefferson IP Law, LLP, Suite 807, 1730 M Street, NW, Washington, DC, 20036, US

(73) Assignee: SAMSUNG ELECTRONICS CO. LTD., Suwon-si (KR)

(21) Appl. No.: 12/502,853

(22) Filed: Jul. 14, 2009

Related U.S. Application Data
(63) Continuation-in-part of application No. 12/498,117, filed on Jul. 6, 2009.

(30) Foreign Application Priority Data
Jul. 4, 2008 (KR) 10-2008-0064660

(51) Int. Cl. G06F 7/38

(52) U.S. Cl. 708/491

(57) ABSTRACT

An apparatus and method for generation of an M-length permutation sequence in a broadband wireless communication system are provided. Operations of a generator include splitting an L2-length seed value into a first part and a second part, determining coefficients of a generator polynomial using values of the first part and the second part, and calculating the permutation sequence using the generator polynomial.

### PRIORITY

The application is a continuation in-part application of the U.S. patent application Ser. No. 12/498,117 filed on Jul. 6, 2009, the entire disclosure of which is hereby incorporated by reference.

### BACKGROUND OF THE INVENTION

1. Field of the Invention

The present invention relates to a broadband wireless communication system. More particularly, the present invention relates to an apparatus and a method for generating a sequence corresponding to a seed value in the broadband wireless communication system.

2. Description of the Related Art

A next-generation communication system aims to provide users with services of various Quality of Service (QoS) levels at a high data rate. Particularly, present-day next-generation communication systems are advancing in order to guarantee mobility and QoS in Broadband Wireless Access (BWA) communication systems such as Wireless Local Area Network (WLAN) systems and Wireless Metropolitan Area Network (WMAN) systems. Representative examples include an Institute of Electrical and Electronics Engineers (IEEE) 802.16a/d communication system and an IEEE 802.16e communication system.

The IEEE 802.16a/d communication system and the IEEE 802.16e communication system adopt an Orthogonal Frequency Division Multiplexing (OFDM)/Orthogonal Frequency Division Multiple Access (OFDMA) scheme to support a broadband transmission network over physical channels of the WMAN system. The IEEE 802.16a/d communication system considers only the fixed status of a current Subscriber Station (SS), that is, only a single-cell structure without considering the mobility of the SS. In contrast, the IEEE 802.16e communication system considers the mobility of the SS in the IEEE 802.16a communication system. A mobile SS is referred to herein as a Mobile Station (MS).

According to a particular pattern defined by a hopping sequence in the communication system, a Base Station (BS) and the MS transmit and receive data with each other. For example, in the communication system of a frequency hopping spread spectrum scheme, the BS and the MS transmit and receive data by hopping or switching a carrier frequency corresponding to the particular pattern defined by the hopping sequence. In the communication system of a time hopping spread spectrum scheme, a data transmission frame is divided into a plurality of time slots. A time slot is selected according to the particular pattern defined by the hopping sequence, and the BS and the MS transmit and receive data in the selected time slot. In the OFDM/OFDMA communication system, a plurality of MSs transmit and receive data in their allocated interval according to the particular pattern defined by the hopping sequence.

The communication system adopts, for example, a permutation sequence as the hopping sequence. The permutation has a one-to-one correspondence from an ordered list set to itself, that is, rearrangement of the order of the elements in the set. For example, the number of permutations in a set including M-ary elements is M!. M! is given by Equation (1).

M!=M×(M−1)× . . . ×1, 0!=1 (1)

In more detail, when various seed values for generating the sequence are input, the communication system generates the sequence by producing different permutations corresponding to the seed values. For example, when an S-bit seed value is input and the M-length permutation is generated, the communication system selects 2^{S} permutations from the M!-ary permutations with respect to all of the 2^{S} possible seed values and maps the seed values to the selected permutations.

Table 1 illustrates an example of generated permutation sequences corresponding to the seed values when M is 7 and S is 5.

TABLE 1

| S4 S3 S2 S1 S0 | Permutation sequence |
|---|---|
| 0 0 0 0 0 | 0, 5, 2, 6, 1, 3, 4 |
| 0 0 0 0 1 | 1, 6, 3, 2, 4, 5, 0 |
| 0 0 0 1 0 | 3, 5, 4, 1, 0, 6, 2 |
| 0 0 0 1 1 | 6, 2, 5, 0, 4, 3, 1 |
| 0 0 1 0 0 | 5, 1, 6, 3, 0, 2, 4 |
| . . . | . . . |
| 1 1 1 1 1 | 4, 0, 2, 6, 1, 3, 5 |

In Table 1, since S is 5, that is, S0, S1, S2, S3 and S4, 2⁵(=32) permutations are selected from all of the possible 7! (=7×6×5×4×3×2×1=5040) permutations with respect to 2⁵(=32) seed values and the seed values, that is, S0, S1, S2, S3 and S4 are mapped to the selected permutations.

As illustrated in Table 1, the seed values and the permutation sequences corresponding to the seed values are stored by a transmitter and a receiver of the communication system. As the seed value S, which produces the permutations, and the sequence length M increase, the seed value and the permutation sequences corresponding to the seed value increase. As a result, a memory capacity of the transmitter and the receiver for storing the permutation sequences must also increase which results in a corresponding increase in an overall size of the transmitter and the receiver.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for reducing the amount of memory necessary to store permutation sequences in a broadband wireless communication system.

Another aspect of the present invention is to provide an apparatus and a method for generating a permutation sequence when the permutation sequence is necessary in a broadband wireless communication system.

In accordance with an aspect of the present invention, a method for generating an M-length permutation sequence in a communication system is provided. The method includes splitting an L2-length seed value into a first part and a second part, determining coefficients of a generator polynomial using values of the first part and the second part, and calculating the permutation sequence using the generator polynomial.

In accordance with another aspect of the present invention, an apparatus for generating an M-length permutation sequence in a communication system is provided. The apparatus includes a splitter for splitting an L2-length seed value into a first part and a second part, a coefficient determiner for determining coefficients of a generator polynomial using values of the first part and the second part, and a calculator for calculating the permutation sequence using the generator polynomial.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will be more apparent from the following description taken in conjunction with the accompanying drawings, in which:

FIG. 1 illustrates a method for generating a permutation sequence in a broadband wireless communication system according to an exemplary embodiment of the present invention;

FIG. 2 illustrates a sequence generator in a broadband wireless communication system according to an exemplary embodiment of the present invention;

FIG. 3 illustrates a transmitting end for interleaving using a permutation sequence in a broadband wireless communication system according to an exemplary embodiment of the present invention; and

FIG. 4 illustrates a transmitting end for frequency hoping using a permutation sequence in a broadband wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide a technique for preventing waste of a memory which stores permutation sequences in a broadband wireless communication system. That is, the present invention provides a technique for generating the permutation sequence if necessary without storing the permutation sequence.

A method for generating a permutation sequence according to an exemplary embodiment of the present invention is described in brief.

A sequence generator according to an exemplary embodiment of present invention determines a seed value of a specific length from a basic seed value. For example, the sequence generator determines an L2-length seed value required to generate the permutation sequence, from the L1-length basic seed value. The L2-length seed value is given by Equation (2).

Y=A·X mod 2^{L2} (2)

In Equation (2), Y denotes the L2-length seed value expressed by a decimal number, A denotes a set variable, and X denotes the L1-length basic seed value expressed by a decimal number.

2^{L2} is a dividend. The modulo operation is conducted so as to generate the L2-length bit output. The decimal number determined for Y is converted to a binary number and becomes the L2-length bit, that is, c_{L2-1} c_{L2-2} . . . c₂ c₁ c₀. In an exemplary implementation, the variable A should be set to a specific constant number. More particularly, conditions of the variable A are described. First, when a different X is input, the variable A should be set so that a different Y is output. For example, when the variable A is a prime number, the first condition is satisfied. Secondly, when adjacent values, for example, 12 and 13 are input as X, the variable A should be set so that output values of Y are not adjacent, but are separate from each other. In an exemplary implementation, when the binary number is considered as the variable A which meets the second condition, it is advantageous that the number of ‘1’s occupies more than half of the total number of digits. In this case, when two adjacent input values, that is, input values which differ by ‘1,’ are under consideration, the output values of the two input values have the same difference as the variable A. When the variable A is expressed as a binary number, the number of ‘1’s in the binary number determines the difference between the output values. Accordingly, as the number of ‘1’s increases in the binary number, the difference between the output values corresponding to the adjacent input values increases. When the variable A is set to meet the above-stated conditions and the basic seed value of the first length is input, the different seed value of the second length is output and randomness of the seed value of the second length is much more likely.

The sequence generator splits the generated seed value into a first part and a second part, makes a generator polynomial for generating the sequence using the first part and the second part, and generates a permutation sequence corresponding to the generator polynomial. For example, the generator polynomial is given by Equation (3).

Y={(D·X+E)mod P} mod M (3)

In Equation (3), Y denotes an output of the polynomial, X denotes an input of the polynomial, D and E denote variables calculated from the seed value, P denotes a set variable, and M denotes a length of the permutation sequence. In an exemplary implementation, P is set as a prime number greater than 2^{L2}.

In the generation of the permutation sequence, an array is necessary to store the permutation sequence in the process of the generation. Hereinafter, to ease the understanding, the array for storing the permutation sequence is referred to as a sequence array. By generating the permutation sequence with the polynomial generated using the seed value, that is, by generating the hopping sequence, the capacity of the memory for storing the seed value and the permutation sequence corresponding to the seed value is reduced.

According to an exemplary embodiment of the present invention, the sequence generator initializes the sequence array, compares a value calculated using the generator polynomial generated by the seed value with the sequence array, swaps the values of the sequence array according to the result of the comparison, and thus generates the permutation sequence.

Now, methods for generating the permutation sequence according to exemplary embodiments of the present invention are elucidated by referring to the drawings.

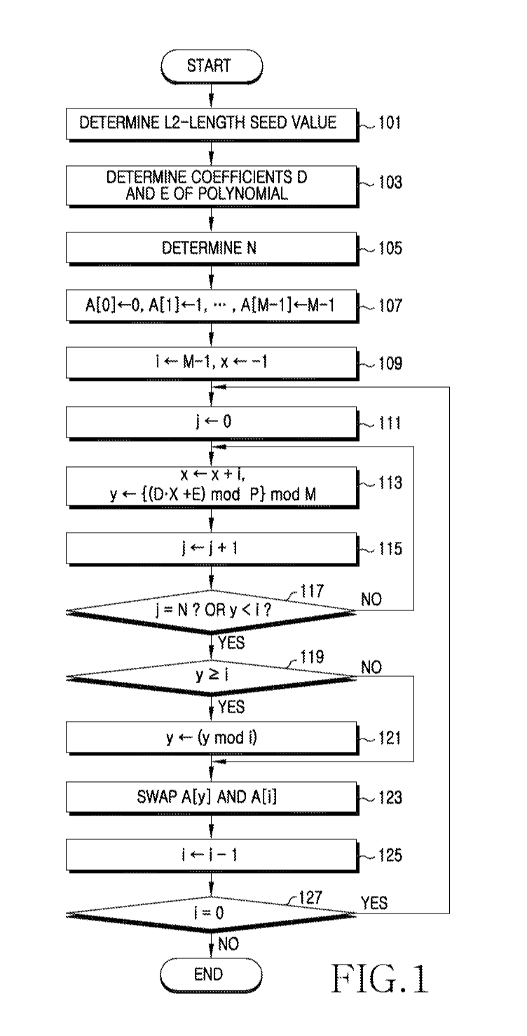

FIG. 1 illustrates a method for generating a permutation sequence in a broadband wireless communication system according to an exemplary embodiment of the present invention.

Referring to FIG. 1, the sequence generator determines the L2-length seed value from the L1-length basic seed value based on Equation (2) in step 101. More specifically, when the L1-length bit, that is, b_{L1-1} b_{L1-2} . . . b₂ b₁ b₀ is input, the sequence generator converts b_{L1-1} b_{L1-2} . . . b₂ b₁ b₀ to the decimal X. The sequence generator multiples X by A and performs the modulo operation on the product of X and A by 2^{L2}. Next, the sequence generator converts the result of the modulo operation, that is, the remainder of the division of the product of X and A by 2^{L2} to a binary number. Hence, the L2-length seed value, that is, c_{L2-1} c_{L2-2} . . . c₂ c₁ c₀ is determined.

In step 103, the sequence generator determines the coefficients D and E of the generator polynomial of Equation (3). The sequence generator splits the L2-length seed value into the first partial seed value d_{L21-1} d_{L21-2} . . . d₂ d₁ d₀ and the second partial seed value e_{L22-1} e_{L22-2} . . . e₂ e₁ e₀. Herein, the sum of L21 and L22 is L2. The sequence generator converts the first partial seed value to a decimal number, adds the set variable v, and sets D to the sum of the first partial seed value converted to the decimal number and the set variable v. According to another exemplary embodiment of the present invention, the set variable v may be certain constant number. The sequence generator converts the second partial seed value to a decimal number and determines E as the second partial seed value converted to the decimal number.

In step 105, the sequence generator determines the number of repetitions N. Herein, N, which is a positive integer, denotes the maximum number of the repetitions of the generator polynomial operation for exchanging the array values for one time.

In step 107, the sequence generator initializes the sequence array for storing the permutation sequence. That is, the sequence generator initializes the elements of the M-size sequence array A[0], A[1], . . . , A[M−1] to 0, 1, . . . , M−1.

In step 109, the sequence generator initializes the variable i to M−1 and the variable x to −1.

In step 111, the sequence generator initializes the variable j to zero.

In step 113, the sequence generator increases the variable x by the variable i and calculates the output of the generator polynomial with the input variable x. Namely, the sequence generator adds the product of x and D with E, performs the modulo operation on the addition result by P, and performs the modulo operation on the result of the modulo operation by T. Next, the sequence generator substitutes the output of the generator polynomial to the variable y.

In step 115, the sequence generator increases the variable j by one.

In step 117, the sequence generator determines whether the variable j is equal to N or the variable y is smaller than the variable i. When the variable j is different from N and the variable y is greater than or equal to the variable i, the sequence generator goes back to step 113.

When the variable j is equal to N or the variable y is smaller than the variable i, the sequence generator determines whether the variable y is greater than or equal to the variable i in step 119. When the variable y is smaller than the variable i, the sequence generator goes to step 123.

When the variable y is greater than or equal to the variable i, the sequence generator conducts the modulo operation on the variable y by the variable i and substitutes the result of the modulo operation to the variable y in step 121.

In step 123, the sequence generator swaps the value of A[y] and the value of A[i]. Namely, the sequence generator substitutes the value of A[y] to A[i] and substitutes the value of A[i] to A[y].

In step 125, the sequence generator decreases the variable i by one.

Next, the sequence generator determines whether the variable i is zero in step 127. When the variable i is not zero, the sequence generator returns to step 111. On the other hand, when the variable i is zero, the sequence generator determines the sequence stored to the current sequence array as the final permutation sequence and finishes this process.

The permutation sequence generation illustrated in FIG. 1 is discussed in more detail below.

The sequence generator determines the L2-length seed value s=[c_{L2-1} c_{L2-2} . . . c₂ C₁ c₀] required for the generation of the permutation sequence, from the L1-length basic seed value, which is the input for generating the permutation sequence, and determines the size M of the permutation sequence. s is the decimal number of the L2-length seed value. Based on the determined L2-length seed value and the size M of the permutation sequence, the permutation sequence [0, 1, . . . , M−1] is produced.

Now, an exemplary structure of a permutation sequence generator is explained in more detail by referring to the drawings.

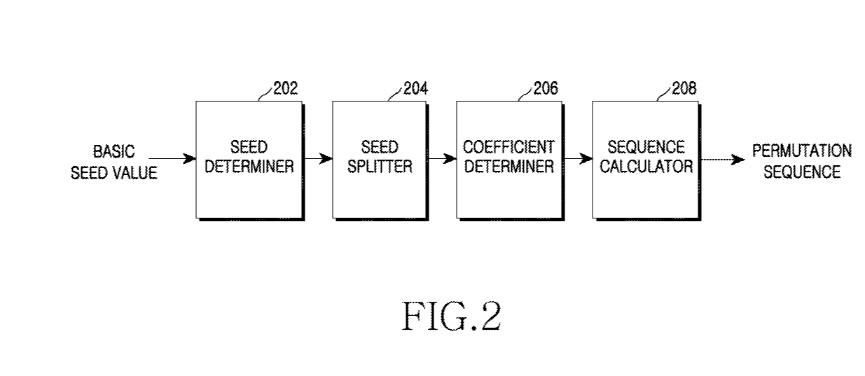

FIG. 2 is a block diagram of a sequence generator in a broadband wireless communication system according to an exemplary embodiment of the present invention.

Referring to FIG. 2, the sequence generator includes a seed determiner 202, a seed splitter 204, a coefficient determiner 206, and a sequence calculator 208.

The seed determiner 202 determines the L2-length seed value from the L1-length basic seed value. That is, the seed determiner 202 reconstructs the L1-length basic seed value b_{L1-1} b_{L1-2} . . . b₂ b₁ b₀ to the L2-length seed value c_{L2-1} c_{L2-2} . . . c₂ c₁ c₀. The seed determiner 202 determines the L2-length seed value based on Equation (2). When the L1-length bit b_{L1-1} b_{L1-2} . . . b₂ b₁ b₀ is input, the seed determiner 202 converts b_{L1-1} b_{L1-2} . . . b₂ b₁ b₀ to the decimal number and substitutes the decimal number to the variable X. The seed determiner 202 multiples the variable X by the variable A and performs the modulo operation on the product of X and A L2 by 2. Next, the seed determiner 202 substitutes the remainder of the division of the product of the variable X and the variable A by 2^{L2} to the variable Y. The seed determiner 202 converts the variable Y to the binary number and thus determines the L2-length seed value.

The seed splitter 204 splits the L2-length seed value determined by the seed determiner 202 to the first partial seed value and the second partial seed value. In more detail, the seed splitter 204 splits the L2-length seed value cL2-1 cL2-2 . . . c2 c1 c0 provided from the seed determiner 202, to the first partial seed value of the L21 length and the second partial seed value of the L22 length. Herein, the sum of L21 and L22 is L2.

The coefficient determiner 206 determines the coefficients D and E of the generator polynomial of Equation (3). The coefficient determiner 206 converts the first partial seed value provided from the seed splitter 204, to a decimal number, adds the set variable v, and sets D to the sum of the first partial seed value converted to the decimal number and the set variable v. The coefficient determiner 206 converts the second partial seed value provided from the seed splitter 204, to a decimal number and determines E as the second partial seed value converted to the decimal number.

The sequence calculator 208 calculates the elements of the permutation sequence, that is, generates the permutation sequence using the generator polynomial of Equation (3) including D and E defined by the coefficient determiner 206. Specific functions of the sequence calculator 208 differ in various exemplary embodiments of the present invention.

According to an exemplary embodiment of the present invention, the sequence calculator 208 calculates the permutation sequence in steps 105 through 129 of FIG. 1. More specifically, the sequence calculator 208 initializes the elements of the sequence array to 0 though M−1, and determines the maximum number N of the repetitions of the generator polynomial operation for exchanging the array values for one time. After initializing the variable i to M−1, the sequence calculator 208 calculates the output value y using the numbers that are {(−1)+(the variable i)×n}, n is integer greater than 0, as the input of the generator polynomial in order and determines whether the output value is smaller than i or the generator polynomial operation reaches the N times in every calculation of the output value y. When the output value y is smaller than i or the generator polynomial operation reaches the N times, the sequence calculator 208 swaps the (y+1)-th element of the sequence array and the (i+1)-th element of the sequence array. When y is greater than or equal to i, the sequence calculator 208 substitutes the result of the modulo operation of y by i to y and swaps the (y+1)-th element of the sequence array and the (i+1)-th element of the sequence array. Next, the sequence calculator 208 decreases i by one and determines whether i is zero. When i is not zero, the sequence calculator 208 continues calculating the output value y. When i is zero, the sequence calculator 208 outputs the current sequence stored to the sequence array as the permutation sequence.

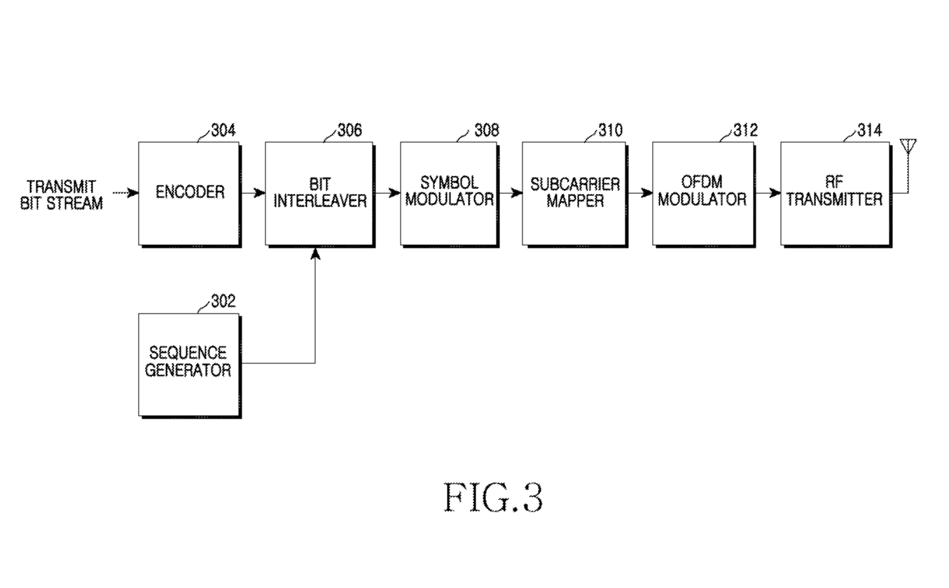

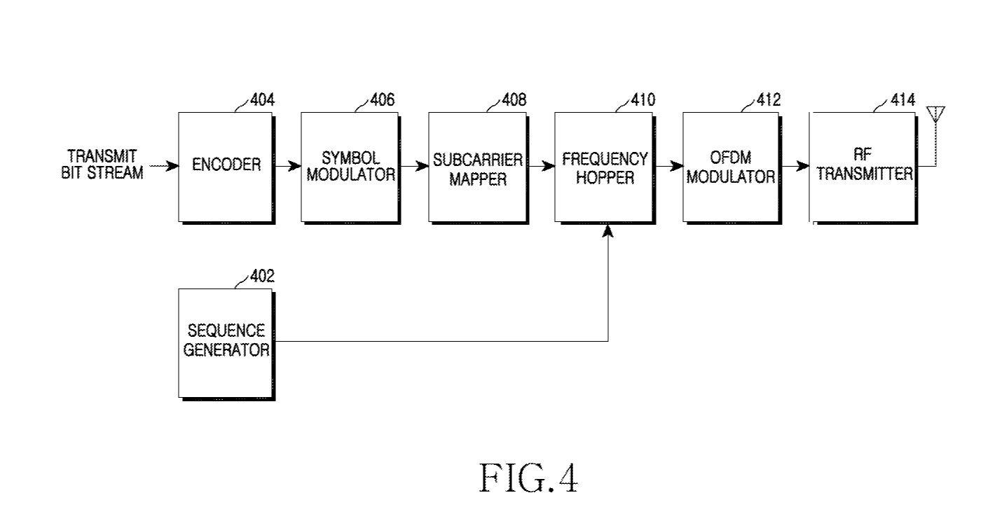

The permutation sequence generated as above can be utilized in various manners in the broadband wireless communication system. For example, the generated permutation sequence can be used for interleaving of the encoded bit stream and frequency hopping as illustrated in FIGS. 3 and 4. Hereinafter, an OFDM/OFDMA wireless communication system is illustrated by way of example. Note that the present invention is applicable to other wireless communication systems.

FIG. 3 is a block diagram of a transmitting end for interleaving using a permutation sequence in a broadband wireless communication system according to an exemplary embodiment of the present invention.

Referring to FIG. 3, the transmitting end for interleaving the encoded bit stream includes a sequence generator 302, an encoder 304, a bit interleaver 306, a symbol modulator 308, a subcarrier mapper 310, an OFDM modulator 312, and a Radio Frequency (RF) transmitter 314.

The sequence generator 302 is constructed as illustrated in FIG. 2 and generates the permutation sequence according to an exemplary embodiment illustrated in FIG. 1 an exemplary embodiment illustrated in FIG. 2. The sequence generator 302 provides the permutation sequence to the bit interleaver 306. The encoder 304 encodes the transmit bit stream. For example, the encoder 304 encodes according to a turbo code scheme or a Low Density Parity Code (LDPC) scheme.

The bit interleaver 306 interleaves the encoded bit stream output from the encoder 304 according to the permutation sequence fed from the sequence generator 302. That is, the bit interleaver 306 splits the encoded bit stream based on the length of the permutation sequence and changes the positions of the bits within the split unit according to the permutation sequence. For instance, when the permutation sequence is ‘3 0 1 2’, the bit interleaver 306 splits the encoded bit stream to four units, and changes the fourth bit to the first position, the first bit to the second position, the second bit to the third position, and the third bit to the fourth position of the four bits. For example, [b0 b1 b2 b3] is interleaved to [b3 b0 b1 b2].

The symbol modulator 308 demodulates the interleaved bit stream output from the bit interleaver 306 to complex symbols. The subcarrier mapper 310 maps the complex symbols output from the symbol modulator 308 to subcarriers. The OFDM modulator 312 converts the frequency-domain signals output from the subcarrier mapper 310 to time-domain signals through Inverse Fast Fourier Transform (IFFT) and constitutes OFDM symbols by inserting a Cyclic Prefix (CP). The RF transmitter 314 up-converts the baseband signal output from the OFDM modulator 312 to an RF signal and sends the RF signal over an antenna.

With the interleaving at the structure of FIG. 3, a receiving end, which communicates with the transmitting end, deinterleaves the signal using the same permutation sequence as used by the transmitting end. Although it is not depicted in the drawing, the receiving end includes a sequence generator and a bit deinterleaver. The sequence generator generates the permutation sequence in the same manner as the sequence generator 302 of the transmitting end. The bit deinterleaver deinterleaves according to the permutation sequence generated by the sequence generator. To generate the same permutation sequences at the sequence generator of the receiving end and the sequence generator 302 of the transmitting end, the receiving end and the transmitting end need to share the same basic seed value. For doing so, the transmitting end and the receiving end share the basic seed value over a separate control channel, or use a pre-agreed value as the basic seed value.

FIG. 4 is a block diagram of a transmitting end for frequency hoping using a permutation sequence in a broadband wireless communication system according to an exemplary embodiment of the present invention.

Referring to FIG. 4, the transmitting end for the frequency hopping includes a sequence generator 402, an encoder 404, a symbol modulator 406, a subcarrier mapper 408, a frequency hopper 410, an OFDM modulator 412, and an RF transmitter 414 as illustrated in FIG. 4.

The sequence generator 402 is constructed as illustrated in FIG. 2 and generates a permutation sequence according to an exemplary embodiment of FIG. 1 or an exemplary embodiment of FIG. 2. The sequence generator 402 provides the permutation sequence to the frequency hopper 410.

The encoder 404 encodes the transmit bit stream. For example, the encoder 404 encodes according to the turbo code scheme or the LDPC scheme. The symbol modulator 406 demodulates the interleaved bit stream output from the encoder 404 to complex symbols. The subcarrier mapper 408 maps the complex symbols output from the symbol modulator 406 to subcarriers.

The frequency hopper 410 frequency-hops the complex symbols mapped to the subcarriers provided from the subcarrier mapper 408, according to the permutation sequence fed from the sequence generator 402. More specifically, with respect to a target of the subcarriers as long as the permutation sequence, the frequency hopper 410 changes the signals mapped to the subcarriers of the target according to the permutation sequence. For instance, when the permutation sequence is ‘3 0 1 2’, the frequency hopper 410 changes the signal mapped to the fourth subcarrier of the four subcarriers to the first subcarrier, the signal mapped to the first subcarrier to the second subcarrier, the signal mapped to the second subcarrier to the third subcarrier, and the signal mapped to the third subcarrier to the fourth subcarrier. In another exemplary implementation, the frequency hopping can be a swap of a certain bundle unit including the plurality of the subcarriers, rather than the swap of the subcarrier unit.

The OFDM modulator 412 converts the frequency-domain signals output from the frequency hopper 410 to time-domain signals through the IFFT and constitutes OFDM symbols by inserting a CP. The RF transmitter 414 up-converts the baseband signal output from the OFDM modulator 412 to an RF signal and sends the RF signal over an antenna.

With the frequency hopping structure of FIG. 4, the receiving end communicating with the transmitting end needs to reverse the frequency hopping using the same permutation sequence as used by the transmitting end. Although it is not depicted in the drawing, the receiving end includes a sequence generator and a frequency dehopper. The sequence generator generates the permutation sequence in the same manner as the sequence generator 402 of the transmitting end. The frequency dehopper reverses the frequency hopping according to the permutation sequence generated by the sequence generator. To generate the same permutation sequences at the sequence generator of the receiving end and the sequence generator 402 of the transmitting end, the receiving end and the transmitting end need to share the same basic seed value. For doing so, the transmitting end and the receiving end share the basic seed value over a separate control channel, or use a pre-agreed value as the basic seed value.

So far, the utilizations of the generated permutation sequence have been described in FIGS. 3 and 4. The interleaving of the encoded bit stream is explained in FIG. 3 and the frequency hopping is explained in FIG. 4. It is apparent that the transmitting end using both of the interleaving and the frequency hopping can make use of the generated permutation sequence. To make the permutation sequence for the interleaving and the permutation sequence for the frequency hopping differ from each other, the transmitting end can use the different permutation sequences by applying different basic seed values.

As set forth above, by generating the permutation sequence using the basic seed value in the broadband wireless communication system, the complexity of the system for storing the permutation sequence can be reduced. While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for generating an M-length permutation sequence in a communication system, the method comprising:
splitting an L2-length seed value into a first part and a second part;
determining coefficients of a generator polynomial using values of the first part and the second part; and
calculating the permutation sequence using the generator polynomial.

2. The method of claim 1, further comprising:
determining the L2-length seed value from a basic seed value.

3. The method of claim 2, wherein the L2-length seed value comprises a binary number determined based on the following equation:
Y=A·X mod 2^{L2}
where Y denotes the L2-length seed value expressed by a decimal number, A denotes a set variable, and X denotes the basic seed value expressed by a decimal number.

4. The method of claim 1, wherein the generator polynomial comprises a polynomial expression given by the following equation:
Y={(D·X+E) mod P} mod M
where Y denotes an output of the polynomial, X denotes an input of the polynomial, D denotes a sum of a decimal number of the first part and a preset value, E is a decimal number of the second part, P denotes a set variable, and M denotes a length of the permutation sequence.

5. The method of claim 4, wherein the calculating of the permutation sequence using the generator polynomial comprises:
initializing a sequence array to 0 through M−1;
initializing a variable i to M−1;
calculating an output value y by sequentially using the numbers that are {(−1)+(the variable i)×n}, n is integer greater than 0, as an input of the generator polynomial, and simultaneously determining whether the output value y is smaller than the variable i or the number of the generator polynomial operations for a single elements swapping reaches the maximum number of repetitions N in every calculation of the output value y; and
when the output value y is smaller than the variable i or the generator polynomial operations reach the N times, swapping a (y+1)-th element of the sequence array and a (i+1)-th element of the sequence array.

6. The method of claim 5, wherein the swapping of the (y+1)-th element of the sequence array and the (i+1)-th element of the sequence array comprises:
when the output value y is greater than or equal to the variable i, substituting a result of a modulo operation of the output value y by the variable i, to the output value y, and swapping the (y+1)-th element of the sequence array and the (i+1)-th element of the sequence array; and
when the output value y is smaller than the variable i, swapping the (y+1)-th element of the sequence array and the (i+1)-th element of the sequence array.

7. The method of claim 6, wherein the calculating of the permutation sequence using the generator polynomial comprises:
after swapping elements, decreasing the variable i by one;
when the variable i is not zero, continuing calculating of the output value y; and
when the variable i is zero, determining a sequence stored to a current sequence array as the permutation sequence.

8. An apparatus for generating an M-length permutation sequence in a communication system, the apparatus comprising:
a splitter for splitting an L2-length seed value into a first part and a second part;
a coefficient determiner for determining coefficients of a generator polynomial using values of the first part and the second part; and
a calculator for calculating the permutation sequence using the generator polynomial.

9. The apparatus of claim 8, further comprising:
a seed determiner for determining the L2-length seed value from a basic seed value.

10. The apparatus of claim 9, wherein the seed determiner determines a binary number determined based on the following equation as the seed value:
Y=A·X mod 2^{L2}
where Y denotes the L2-length seed value expressed by a decimal number, A denotes a set variable, and X denotes the basic seed value expressed by a decimal number.

11. The apparatus of claim 8, wherein the generator polynomial comprises a polynomial expression given by the following equation:
Y={(D·X+E) mod P} mod M
where Y denotes an output of the polynomial, X denotes an input of the polynomial, D denotes a sum of a decimal number of the first part and a preset value, E is a decimal number of the second part, P denotes a set variable, and M denotes a length of the permutation sequence.

12. The apparatus of claim 11, wherein the calculator initializes a sequence array to 0 through M−1, initializes a variable i to M−1, calculates an output value y by sequentially using the numbers that are {(−1)+(the variable i)×n}, n is integer greater than 0, as an input of the generator polynomial and simultaneously determines whether the output value y is smaller than the variable i or the number of the generator polynomial operations for a single elements swapping reaches the maximum number of repetitions N in every calculation of the output value y, and swaps a (y+1)-th element of the sequence array and a (i+1)-th element of the sequence array when the output value y is smaller than the variable i or the generator polynomial operations reach the N times.

13. The apparatus of claim 12, wherein, when the output value y is greater than or equal to the variable i, the calculator substitutes a result of a modulo operation of the output value y by the variable i, to the output value y and swaps the (y+1)-th element of the sequence array and the (i+1)-th element of the sequence array, and
when the output value y is smaller than the variable i, the calculator swaps the (y+1)-th element of the sequence array and the (i+1)-th element of the sequence array.

14. The apparatus of claim 13, wherein the calculator, after exchanging elements, decreases the variable i by one, continues calculating of the output value y when the variable i is not zero, and determines a sequence stored to a current sequence array as the permutation sequence when the variable i is zero.
